(19) United States
(12) Patent Application Publication
(10) Pub. No.: US 2001/0017149 A1
(43) Pub. Date: Aug. 30, 2001

(54) "Mechanical clutch assembly for cleaning machine transmission shafts"

(75) Inventor: Michele Massaro, Noventa padovana (IT)

Correspondence Address: MODIANO & ASSOCIATI, Via Meravigli, 16, Milano, 20123, IT

(73) Assignee: LINDHAUS S.r.1.

(21) Appl. No.: 09/790,863

(22) Filed: Feb. 23, 2001

(30) Foreign Application Priority Data
Feb. 29, 2000 (IT) PD2000A000056

(51) Int. Cl. F16D 11/14; F16D 43/202

(52) U.S. Cl. 134/112; 192/56.61

(57) ABSTRACT

A mechanical clutch assembly, particularly for rotary motion transmission shafts in household or professional cleaning machines. The assembly comprises a first driving disk and a second driven disk which are inserted coaxially in a transmission shaft; the first driving disk is fixed to the shaft and the second driven disk is free with respect to the shaft and is associated, so that it is free to perform a translation movement along the axis of the shaft, with a transmission coupling connected to a corresponding cleaning tool. The first and second disks have, on mutually opposite faces, first radially protruding teeth which are adapted to mesh together, so as to ensure the transmission of motion up to a preset value of the torque; the coupling, which is free with respect to the shaft, accommodates pusher elements for the second disk which are adapted to keep the second disk pushed so as to mesh with the first disk up to preset limits of transmitted torque.

### BACKGROUND OF THE INVENTION

The present invention relates to a mechanical clutch assembly, particularly for rotary motion transmission shafts, in household or professional cleaning machines.

It is known that several machines or tools suitable to improve and facilitate cleaning both in household and in professional sectors have long been used successfully.

Merely as an example, mention is made of machines such as vacuum cleaners, polishing machines, electric brushes, electric brooms, devices that emit pressurized steam, and the like.

These machines, though belonging to different types, often have as their working ends, tools which are usually interchangeable and act directly on the surfaces or items to be cleaned.

In particular, many tools have rotating elements which typically perform a mechanical cleaning, possibly associated with other cleaning devices, for example of the type with fluid jets, such as steam or the like.

Experience in application has shown that these rotating elements, when encountering particularly resistant obstacles or hindrances, are subjected to a resistance which exceeds their torque and accordingly jam.

This jamming, transmitted backward along the kinematic chain, can damage the weaker components of said chain: for example, linkages or transmissions can break, or even the motor can be damaged if jamming persists for some time.

### SUMMARY OF THE INVENTION

The aim of the present invention is to provide a mechanical clutch assembly, particularly for rotary motion transmission shafts of household or professional cleaning machines, which solves the above described drawbacks, particularly ensuring a maximum limit of the torque that can be transmitted to the cleaning tools, beyond which, if the stall torque encountered by said tools exceeds said limit value, a slippage, in some point of the kinematic transmission chain, is provided which is suitable to ensure the mechanical and functional protection in general of the components of said chain.

Within this aim, an important object of the present invention is to provide a clutch assembly, which can be easily applied to different kinds of cleaning machine.

Another object of the present invention is to provide a clutch assembly whose dimensions can be chosen in the most flexible manner according to the requirements encountered in terms of maximum transmissible torque.

Another object of the present invention is to provide a clutch assembly which is absolutely safe for the machine and for the user, may optionally have settings performed on the spot before cleaning, and can indicate to the operator in some way that the maximum transmissible torque has been exceeded.

Another object of the present invention is to provide a clutch assembly which can be manufactured at competitive costs with respect to solutions having a similar functionality and can also be manufactured with known technologies.

This aim and these and other objects which will become better apparent hereinafter are achieved by a mechanical clutch assembly, particularly for rotary motion transmission shafts in household or professional cleaning machines, characterized in that it comprises a first driving disk and a second driven disk inserted coaxially in a transmission shaft, said first driving disk being fixed to said shaft and said second driven disk being free with respect to said shaft and being associated, so that it is free to perform a translation movement along the axis of said shaft, with a transmission coupling which is in turn connected to a corresponding cleaning tool, said first and second disks having, on mutually opposite faces, first radially protruding teeth which are adapted to mesh together, said coupling, which is free with respect to said shaft, accommodating pusher means for said second disk which are adapted to keep said first teeth meshed up to preset limits of transmitted torque.

### BRIEF DESCRIPTION OF THE DRAWINGS

Further characteristics and advantages of the present invention will become better apparent from the following description of a preferred embodiment thereof, illustrated only by way of non-limitative example in the accompanying drawings, wherein:

FIG. 1 is an exploded view of a mechanical clutch assembly according to the invention;

FIG. 2 is a sectional orthographic projection view of the assembly of FIG. 1.

### DESCRIPTION OF THE PREFERRED EMBODIMENTS

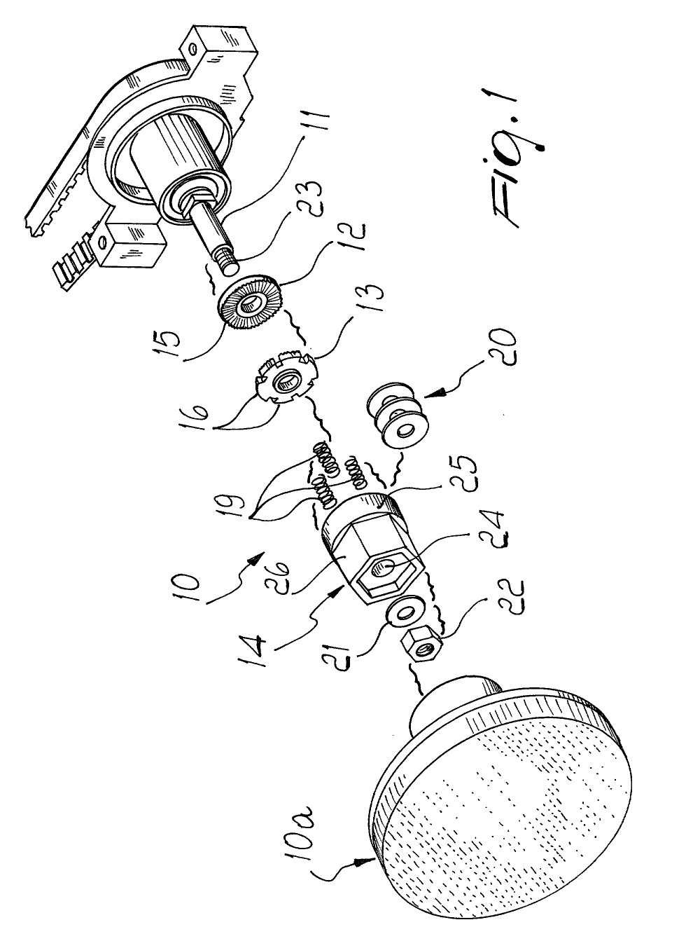

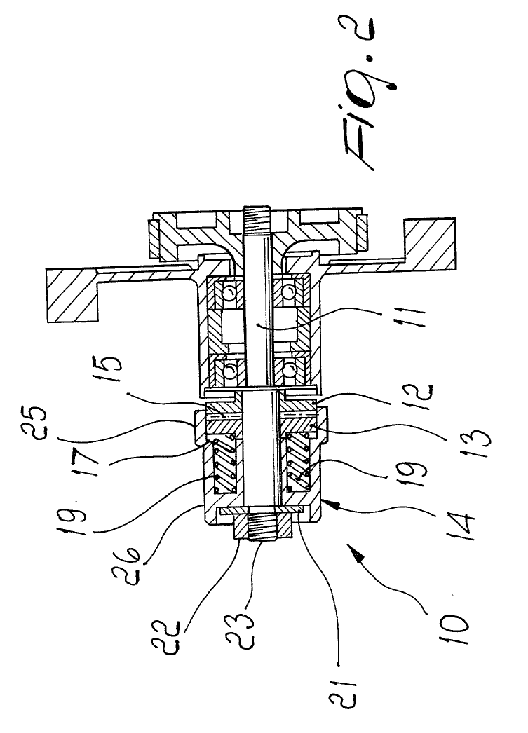

With reference to FIGS. 1 and 2, a mechanical clutch assembly, particularly for rotary motion transmission shafts in household or professional cleaning machines, according to the invention, is generally designated by the reference numeral 10.

In particular, the assembly 10 comprises a first driving disk 12 and a second driven disk 13 which are inserted coaxially in a shaft 11, which in this case is a secondary transmission shaft but can be a motor shaft in other cases; the first disk 12 is rigidly coupled to said shaft 11 and the second disk 13 is free with respect to said shaft and is associated, so that it is free to perform a translation movement with respect to the axis of said shaft 11, with a transmission coupling 14 which is in turn connected to a corresponding cleaning tool 10a of a per se known commercially available type (for example a rotating brush as shown in the figure or a roller provided with bristles).

The first disk 12 and the second disk 13 have, on mutually opposite faces, first radially protruding teeth, of which only the ones designated by the reference numeral 15 are visible in the figures; said teeth are adapted to mesh one another in order to ensure transmission of motion up to a preset value of the torque.

Said coupling 14, which is free with respect to the shaft 11, in this case accommodates pusher means (described hereinafter) for said second disk 13, being suitable to keep said second disk pushed so as to mesh with the first disk 12 up to preset limits of transmitted torque.

The second disk 13 has, in this case, a ring of second teeth 16, which are suitable to lock it rotationally within a corresponding complementarily shaped seat 17 being formed in the coupling 14 and in which it can slide axially.

The pusher means accommodated in the seat 17 of the coupling 14 are constituted by a plurality of elastic elements.

In particular, in this case they are constituted by three helical springs 19.

FIG. 1, however, shows to one side a possible different embodiment which provides, instead of the helical springs 19, Belleville spring washers 20.

The assembly 10 further comprises locking means which are constituted by a washer 21 and a nut 22 being coupled to a corresponding threaded portion 23 in an end region of the shaft 11.

In particular, the above described locking means prevent the sliding of the coupling 14 under the action of said pushing means.

The coupling 14 further has an axial hole 24 in which the shaft 11 is inserted and comprises a first hollow section 25 which continues with a second section 26 for coupling to the cleaning tool.

In particular, the second section 26 is shaped like a hexagonal coupling shank.

In practice it has been observed that the present invention has achieved the intended aim and objects.

In particular, it should be noted that the invention, thanks to a constructively simple solution, optimally solves the problem of transmitting adequate torques which do not damage the various components.

If the tool is subjected to a contrast torque higher than a preset limit, the first meshing teeth in fact produce a thrust on the second disk greater than the thrust of the helical springs or of the Belleville spring washers, thus causing functional separation of the first and second disks from each other.

Moreover, since said separation is not complete, the first mutually opposite teeth collide with each other, producing a characteristic noise which is a warning to the operator, who can thus switch off the machine or remove the obstacle.

It should also be noted that the assembly according to the invention has an extremely flexible structure which can be applied to substantially any kind of cleaning machine.

Attention is also called to the overall simplicity and sturdiness of the invention, which make it applicable in particularly demanding operating conditions.

The present invention is susceptible of numerous modifications and variations, all of which are within the scope of the appended claims.

The technical details may be replaced with other technically equivalent elements.

The materials and the dimensions may be any according to requirements.

The disclosures in Italian Patent Application No. PD2000A000056from which this application claims priority are incorporated herein by reference.

What is claimed is:

1. In a cleaning machine, a mechanical clutch assembly for rotary motion transmission shafts comprising: a first driving disk; a second driven disk, said first and second disks being arranged coaxially on a transmission shaft rotatable about an axis thereof; a transmission coupling freely movable with respect to the shaft and connected to a corresponding cleaning tool of said cleaning machine; said first driving disk being fixed to said shaft and said second driven disk being mounted on the shaft in coupling relationship with said transmission coupling and so as to perform translation movements along the axis of said shaft; first radially protruding teeth, provided on corresponding faces of said first and second disks which are opposite to each other so as to mesh together; and pusher means accommodated in said coupling for pushing said second disk towards said first disk so as to keep said first teeth meshed up to preset limits of transmitted torque.

2. The assembly of claim 1, wherein said second disk has a ring of second teeth and said coupling comprises a corresponding complementarily shaped seat formed therein, said second teeth being lockable in said shaped seat whereby to prevent rotation of said second disk.

3. The assembly of claim 2, wherein said pusher means are accommodated in said seat of said coupling.

4. The assembly of claim 3, wherein said pusher means comprise at least two elastic elements.

5. The assembly of claim 3, wherein said pusher means comprise at least two helical springs.

6. The assembly of claim 3, wherein said pusher means comprise at least one Belleville spring washer.

7. The assembly of claim 3, further comprising blocking means for preventing axial sliding of said coupling following pushing action of said pushing means.

8. The assembly of claim 7, wherein said blocking means are constituted by a washer and a nut, said nut being coupled to a corresponding threaded portion which is formed in an end region of said application shaft.

9. The assembly of claim 2, wherein said coupling comprises an axial hole in which said shaft is inserted, a first hollow section which forms said s seat, and a second section for coupling to the cleaning tool.

10. The assembly of claim 9, wherein said second section is shaped so as to form a coupling shank which has a shape adapted to engage in a rotation transmission configuration said cleaning tool.
